(19) United States
(12) Patent Application Publication
(10) Pub. No.: US 2005/0144029 A1
(43) Pub. Date: Jun. 30, 2005

(54) Systems and methods for aesthetic improvement

(76) Inventors: Richard R. Rakowski, West Palm Beach, FL (US); Kelly Charron, West Palm Beach, FL (US)

Correspondence Address: JENKENS & GILCHRIST, PC, 1445 ROSS AVENUE, SUITE 3200, DALLAS, TX, 75202, US

(21) Appl. No.: 10/863,856

(22) Filed: Jun. 8, 2004

Related U.S. Application Data
(60) Provisional application No. 60/533,731, filed on Dec. 31, 2003.

(51) Int. Cl. G06F 17/60

(52) U.S. Cl. 705/1

(57) ABSTRACT

Systems and methods consistent with the invention may be used to provide a user with an aesthetic improvement procedure comprising, obtaining information from the user regarding the aesthetic improvements desired by the user, consulting with individual providers of aesthetic improvements for recommendations, performing the recommended aesthetic improvement procedures and assessing the outcome of the aesthetic improvements in an integrated and objective manner.

### BACKGROUND OF THE INVENTION

1. Field of the Invention

The present invention generally relates to systems and methods for measuring and improving the aesthetics of a user's appearance (i.e., the level or degree of beauty or attractiveness of a user's face and body).

2. Description of Prior Art

Under current market practice, a user who desires to improve their physical appearance can do so only in a fragmented and step-by-step manner. Current market practice involves specific (appearance improvement) domain providers (e.g., hair stylists, hair colorists, makeup artists, aestheticians, plastic surgeons, cosmetic dermatologists and cosmetic dentists) who are capable of providing aesthetic improvement services only in their own areas of expertise and have little or no knowledge of the other (highly interdependent) domains in the aesthetics arena, and as such are not able to provide an integrated plan or capability to optimize a user's appearance improvement. By way of example, if a user desires to understand how to optimally maximize their physical appearance, they may be required to consult with, among others, a plastic surgeon, a hair stylist, a nail technician, and a make-up artist. Each of these providers is likely to have different overall view of how that user should look both within and outside their areas of expertise. As a result, the user is faced with having to interpret each of these differing views.

Furthermore, in the current marketplace, user and appearance improvement providers can assess the results of an aesthetic improvement procedure only by subjective methods. In other words, the process of assessing what should be done to improve a user's appearance is driven by the provider rather than the user. In sum, the current market practice is fragmented, subjective and driven by the provider.

Additionally, in the current market practice, cosmetic dermatology procedures are conducted without the use of needed standardized information for providers to be able to assess and repeat the procedures and/or the aesthetic improvement results they are intended to create.

There is therefore a need for a new business model specifically developed for the user aesthetics improvement market that addresses the objectivity, i.e., “measurability” of appearance improvement and provides a holistic solution for the integration of disparate domains.

### SUMMARY OF THE INVENTION

An aspect of the invention provides a method of providing a user with an aesthetic improvement procedure comprising: obtaining information from the user regarding the aesthetic improvements desired by the user, consulting with individual providers of aesthetic improvements for recommendations, developing a comprehensive aesthetic improvement plan, performing the recommended aesthetic improvement procedures and assessing the outcome of the aesthetic improvements in an integrated and objective manner.

An aspect of the invention provides users and aesthetic improvement providers with objective or standardized bases for measuring the degree of improvement that results from the performance of an aesthetic improvement procedure.

Another aspect of the invention provides a method of providing a user with an outcome evaluation to an aesthetic improvement procedure using one or more tools to assess user appearance.

An aspect of the invention provides a method of providing a user with an aesthetic improvement procedure comprising providing the user with a single systems integrator who manages the user's aesthetic improvement.

An aspect of the invention provides a method for improving the assessment of the results and repeatability of cosmetic dermatological procedures.

### BRIEF DESCRIPTION OF THE DRAWINGS

The accompanying drawings which are incorporated in and constitute a part of this specification exemplify the invention and together with the description, serve to explain the principles of the invention:

FIG. 1 illustrates an embodiment of the invention in which a user consults with a concierge;

FIG. 2 illustrates an aspect of the invention namely, the integrated consultation process;

FIG. 3 illustrates an embodiment of the invention in which a user obtains a comprehensive diagnostic analysis;

FIG. 4 illustrates an embodiment of the invention using a retrospective outcomes approach;

FIG. 5 illustrates an embodiment of the invention using a prospective outcomes approach;

FIG. 6 illustrates an embodiment of the invention using a procedure to create repeatable results in cosmetic dermatology delivery services; and

FIG. 7 illustrates an embodiment of the invention demonstrating the consistency and repeatability of a cosmetic dermatology procedure.

### DESCRIPTION OF EXEMPLARY EMBODIMENTS

Reference will now be made in detail to the invention, examples of which are illustrated in the accompanying drawings.

Historically, there has been a belief on the part of both users and providers of aesthetic improvement services that an assessment of an individual's physical appearance is more subjective, i.e., in the eye of the beholder, rather than objective, i.e., quantifiable by measurable data. In an exemplary embodiment of the invention, a process for evaluating an aesthetic improvement by objective standards is provided. This embodiment serves to move the evaluation of “beauty” from the realm of the subjective more towards the objective and permits the quantifiable assessment of both a user's pre-procedure appearance and the improvement of the user's appearance following one or more aesthetic improvement procedures.

As used herein, the term “aesthetic improvement” or “aesthetic improvement procedure” involves the influence, involvement and integration of nine key contributing user face and body appearance improvement domains namely:
1. Plastic surgery for facial and body improvements that remove, change or influence an aesthetic issue (e.g., unattractive facial or body feature) or enhance skin quality or enhance an existing facial or body feature;
2. Cosmetic dermatology for skin-related improvements to either remove, change or influence an aesthetic issue (e.g., unattractive facial or body feature) or enhance skin quality or enhance an existing facial or body feature;
3. Cosmetic dentistry for smile-related improvements that focus on the color, structure and symmetry of a user's teeth;
4. Hair styling for the improvement of a user's hair style (specifically the shape, length and degree of curliness/straightness) as it relates to a user's face and body shape and color;
5. Hair coloring for the change or improvement of a user's hair color (specifically covering age-related grayness, providing enhanced facial appearance with a color change or using highlights to improve a user's overall facial appearance);
6. Facial aesthetics for the improvement of non-medical facial related issues, e.g., eye brow shaping, facial hair removal and blackhead removal;
7. Makeup artistry for facial and body improvements to either remove, change or influence an aesthetic issue (e.g., unattractive facial or body feature) or enhance an existing facial or body feature through the most effective use/application of foundations, mascara, lipstick, and other forms of makeup.
8. Fashion and eyewear consultation for optimizing a user's appearance by selecting ideal materials, colors and shapes of clothes and eyewear for their specific (skin, eye or hair) coloring and body and face shape; and
9. Nail care for optimizing the appearance of a user's feet and hands by lengthening, cutting, shaping and coloring the nails on a user's hands and feet.

An aspect of the invention is to provide a user with the ability to objectively measure the results of one or more specific aesthetic improvement procedures. An exemplary embodiment of the invention provides one or more methods of measuring the outcome, i.e., results of an aesthetic improvement procedure.

As used herein, the term “user” refers to an individual who is interested in having one or more aesthetic improvement procedures performed on their face, body or both. The term “user” is also intended to refer to an individual who is the recipient of one or more aesthetic improvement procedures. The terms “user” and “consumer” have been used interchangeably herein.

As used herein, the term “outcome” can be divided into two segmentations. First, a retrospective outcome, which involves informing a user of their specific outcome as a result of a completed aesthetic improvement procedure. Second, a predictive/prospective outcome, which involves informing a user of the outcome they can individually and specifically expect in advance of a procedure being performed on them.

An embodiment of the invention provides a method of measuring an outcome of an aesthetic improvement procedure retrospectively, wherein one or more aesthetic improvement procedures are performed on a user followed by a comparison of the user's appearance after the performance of the one or more procedures to the user's appearance before the performance of any procedure. User appearance, both before and after the performance of one or more aesthetic improvement procedures is assessed by using one or more user appearance assessment tools.

Another embodiment of the invention provides a method of measuring an outcome of an aesthetic improvement procedure prospectively, wherein a user who is desirous of undergoing one or more aesthetic improvement procedures, engages in one or more consultations with a concierge and a diagnostician following which, one or more aesthetic improvement procedures are recommended to the user. The user is further provided with a predicted appearance outcome for the specific aesthetic improvement procedures recommended to the user. This predicted outcome is based on appearance improvement data collected for prior users, as stored in a populations outcome database, who have undergone the specific or substantially similar procedures desired by the present user.

An exemplary embodiment of the invention provides an objective and standardized framework for outcome measurement to the aesthetics improvement market. Another aspect of the invention is to provide improved levels of comfort, safety and peace of mind to a user before, during and following the administration of an aesthetic improvement procedure, compared to current market practice.

Another aspect of the invention is to improve consistency of cosmetic dermatology procedures by “recording” medical interventions so that subsequent interventions can be repeated or improved. The desired repeatability and consistency is obtained by employing practices which are analogous to the types of practices currently employed in the filed of dentistry. For example, in the case of consumable aesthetic services including, but not limited to, botulinum toxin injections (BOTOX®), soft tissue fillers and laser treatments, certain key protocol domains may be followed, which will provide an optimal degree of consistency and predictability of a user's aesthetic improvement results.

An aspect of the invention provides the ability to predict the outcome of a dermatology procedure on the basis of prior results/outcomes which have been compiled in a database.

An exemplary embodiment of the invention provides the integration of the various aesthetic improvement domains using a solution platform that uses a single systems integrator, i.e., a “concierge,” to drive and supervise a user's aesthetic improvement.

The invention may be used to aid users in improving the aesthetics of their face or body. That is, based on user-specific information, the invention may provide a user with aesthetic improvement advice, such as recommended cosmetic enhancement procedures or any one or more of available aesthetic improvement domains. The recommended procedures may complement (physically, physiologically, psychologically, biologically, and/or aesthetically) one another. The recommendation of complementary procedures may not only be a function of the selection of a particular aesthetic improvement procedure, but may also be a function of personal characteristics of the user. So, for example, based on a selection of cosmetic dermatology, facial skin tone, hair color and eye color, a method consistent with the invention may identify a recommended level or type of make-up artistry. The nine appearance improvement domains include, but are not limited to, plastic surgery, cosmetic dermatology, cosmetic dentistry, hair styling, hair coloring, facial aesthetics, make-up artistry, fashion and eyewear consultation and nail care.

In an embodiment of the invention, information is received from a user (100) regarding one or more of the user's facial and body features and the aesthetic improvements they wish to have performed. The reception of the user-specific information may be performed using one or more of a network, oral communication, visual communication, written communication, physical data carrier, and/or any other means capable of conveying information.

The user-specific information may be organized into categories, such as personal information, identifications of user-sought improvements, etc. Personal information may include demographics, skin and body conditions (e.g., skin type, skin texture, skin tone, wrinkles, hair color, hair style, hair condition, eye color, etc.), age, facial features, purchase history, cosmetic color, allergy information, climate information, lifestyle information, product preferences, fashion preferences, prior purchases, and prior expressed interests. It should be noted that the term “user-specific information” is not necessarily related to any particular user. In this regard, the present document uses the term subject-specific information interchangeably with the term user-specific information and neither term is necessarily tied to a particular individual engaging in a particular activity.

Consistent with the invention, a method may also include accessing a database containing information reflecting relationships between categories of user-specific information and aesthetic improvement advice. The purpose of accessing such a database is to ascertain the relational basis between the user-specific information and the advice sought by specific users.

In an embodiment of the invention, one or more user appearance assessment tools may be used to assess user appearance. These tools include, but are not limited to, a concierge who serves as a single point of contact for a user seeking aesthetic improvements, an integrated consultation process, a feature-related flip chart, a diagnostic room, a diagnostician, a self-perception questionnaire, an electronic photograph system, an electronic image database, an electronic system for electronic image morphing, a user satisfaction survey, a beauty analysis system, a wrinkle measurement system, a tooth whiteness measurement system, an expert panel measurement tool, a beauty blueprint report, and an outcomes measurement report.

In certain embodiments of the invention, one or more user appearance assessment tools are undertaken by or performed on the user before the performance of one or more aesthetic improvement procedures. In certain aspects of the invention, an initial user appearance assessment is conducted prior to the performance of any aesthetic improvement procedures.

In other embodiments of the invention, one or more user appearance assessment tools are undertaken by or performed on the user after the performance of one or more aesthetic improvement procedures. In certain aspects of the invention, a user appearance assessment is conducted at the conclusion of one aesthetic improvement procedure and prior to the commencement of the another. In other aspects of the invention, a final user appearance assessment is conducted following the performance of all aesthetic improvement procedures recommended to and/or desired by a user.

An embodiment of the invention provides a user with a “concierge”, i.e., a single systems integrator to drive and supervise a user's aesthetic improvement. For example, a user meets with a concierge, a trained professional who is the user's primary contact during the aesthetic improvement process, and provides user-specific information to identify the user's appearance-related issues, concerns and needs. This process results in the identification of all the user's aesthetic needs (hair, eyes, lips, overall face, overall skin, legs, buttocks, breasts, arms, legs, stomach/abs, neck/back) that are articulated from the user's point of view. This is followed by a detailed user-concierge discussion or consultation about each of the areas identified by the user and how they tie together to impact the user's overall appearance.

A method consistent with the invention provides a comprehensive aesthetic diagnostic analysis. In certain aspects of the invention, the aesthetic diagnostic analysis includes, but is not limited to, assessment of skin quality, facial feature symmetry (including dental symmetry) and teeth color quality. An integrated provider analysis and review session is conducted by the concierge with all of the relevant aesthetic providers (plastic surgeons, cosmetic dermatologists, cosmetic dentists, hair stylists, hair colorists, make-up artists and fashion/image consultants) to review the data collected during the diagnostic analysis. Here, the concierge serves as a central distribution and collection agent for the user's aesthetic assessments and provider inputs and mediates the aesthetic improvement processes desired by the user.

In an embodiment of the invention, a feature-related flip chart may be used to allow a user to identify their needs and concerns. The chart utilizes pictures of facial and body features and describes the issues and concerns that the user has with particular facial and body features.

Consistent with the invention is a diagnostic room where a user can optionally participate in one or more of the following: meet with a diagnostician, fill out a self perception questionnaire, have an electronic photo taken, undergo a beauty analysis using a beauty analysis system, undergo a wrinkle measurement analysis using a wrinkle measurement system and a teeth whitening analysis using a teeth whitening measurement system. A diagnostician is a trained professional who assists the user with one or more of the above-identified activities. In certain aspects of the invention, the concierge also fulfils the role of the diagnostician.

Consistent with the invention, the concierge engages in a first consultation with individual aesthetic improvement providers. These providers include, but are not limited to, a plastic surgeon, a cosmetic dermatologist, a cosmetic dentist, a hair stylist, a hair colorist, a facial aesthetician, a make-up artist, a fashion and eyewear consultant, and a nail care professional. The providers utilize the diagnostic data acquired to assess which procedures inside their own domain will have the maximum appearance improvement impact on the user. Following the first consultation between the concierge and the aesthetic improvement providers, the concierge and user choose the relevant aesthetic improvement providers who will provide the aesthetic improvements to the user.

After obtaining individual input from the providers, the concierge engages in a second consultation with all of the relevant providers to integrate the improvements sought by the user on behalf of an optimized whole. The primary purpose of the second consultation is to optimize the overall aesthetic improvement of the user by ensuring that the individual improvements recommended by multiple providers are compatible with one another and do not create an adverse outcome for the user. For instance, a specific improvement recommended by a plastic surgeon e.g., a nose reduction procedure, which would provide an aesthetic improvement to the user on its own, may be incompatible in conjunction with an improvement recommended by an eye wear consultant, i.e., eye wear selection is incompatible with the shape of the user's nose following the reduction procedure.

Following the second consultation with the relevant aesthetic improvement providers, the concierge develops a detailed aesthetic-improvement plan for the user, which describes all of the proposed interventions/improvement procedures in the appropriate sequence by prioritizing the recommended procedures for maximum improvement, minimum cost, minimum invasiveness, maximized comfort and maximum convenience.

An example of an electronic photograph system that may be used in an embodiment of the invention is the Canfield system (www.canfieldsci.com), although other comparable systems or methods may be used in place of the Canfield system. The electronic photograph system facilitates assessing the visual changes that occur from aesthetic improvement procedures by standardizing “before” and “after” images of the user's face and body. In certain embodiments, the electronic photograph of the user is morphed to take into account the changes that aesthetic improvement procedures will create on the user. The images generated using the electronic photograph system are stored in a database and organized and categorized to allow a level of standardization so that a user's “before” image may be compared to the “before” images of one or more prior users who have undergone similar aesthetic improvements. The electronic photograph database would also allow the comparison of a user's “after” image to the “after” images of one or more prior users who have undergone the same or substantially similar aesthetic improvements. This capability allows a diagnostician to drive the process of morphing software manipulation so that potential users may be able to view actual images of a previous user before and after the administration of one or more aesthetic improvement procedures. This methodology differs from the traditional use of idealized imagery, which does not reflect an actual case performed on a prior user.

An embodiment of the invention provides a user with an opportunity to complete a user satisfaction survey and a standardized attitudinal survey, which measures self-esteem and satisfaction with the body image before and after the performance of one or more aesthetic improvement procedures. These two survey tools permit a diagnostician to measure the user's satisfaction and dissatisfaction with specific features on the user's face and body. The survey tools further allow (i) a diagnostician to recommend one or more aesthetic improvement procedures to the user based on the user's responses to the survey, and (ii) provide the enterprise with an ability to measure specific satisfaction outcomes from the procedures themselves.

In other embodiments of the invention, a user satisfaction survey is also performed after the performance of one or more aesthetic improvement procedures. The post-procedure survey permits a diagnostician to assess a user's satisfaction and dissatisfaction with the results of the aesthetic improvement procedures performed on the user.

An example of a beauty analysis system that may be used in an embodiment of the invention is the Marquardt system, although other systems or methods may be used in place of the Marquardt system. U.S. Pat. No. 5,867,588 and U.S. Pat. No. 5,659,625 disclose and claim the Marquardt beauty analysis system, and are fully incorporated by reference herein.

An example of a wrinkle measurement system that may be used in an embodiment of the invention is the Lemperle system, developed by Dr. Stefan Lemperle. However, other systems or methods may be used in place of the Lemperle system, including but not limited to, the Visia system and Canfield system, which measure skin wrinkling, skin pore size, UV damage of skin and skin consistency.

Consistent with the invention, an expert panel measurement may be employed in an embodiment of the invention. This tool will provide an assessment of the aesthetic improvement provided to a user as a result of one or more procedures on an objective measurement scale, for e.g., a scale of 0-5, and thereby provide standardized and measurable outcomes on both an individual and a population basis.

In an embodiment of the invention, a panel of experts comprising at least one concierge, who serves as the contact point for a user, and one or more aesthetic improvement providers meet to discuss the types of aesthetic improvement procedures that a user would benefit from, based on user-specific information.

In other aspects of the invention, a panel of experts and at least one concierge participate in a review process after the performance of one or more aesthetic improvement procedures on the user, based on the results of user feedback and post-procedure satisfaction surveys.

In an embodiment, a method may optionally include providing and/or performing one or more aesthetic improvement procedures to a user. Provision of the procedures is performed using a “concierge” system, i.e., a solution platform which uses a single systems integrator to drive and supervise a user's aesthetic improvement.

A method consistent with the invention provides the user with the recommended aesthetic improvement procedures. In an embodiment of the invention, a post-procedure aesthetic diagnostic analysis is performed on the user in order to gather quantitative improvement metrics. In addition, self-reported user satisfaction data is obtained and combined with the outcomes of an aesthetic review panel to assess, capture and quantify aesthetic improvements as a result of the procedures performed.

An embodiment of the invention allows a user to identify aesthetic issues and needs as part of a single solution delivery capability that is facilitated by a comprehensive and integrated user-driven system which brings together disparate and disconnected procedures and inventions into a single/holistic solution for the user.

An embodiment of the invention provides a quantitative database of metric data that quantifies the user's appearance before and after the performance of one or more aesthetic improvement procedures and provides an objective measurement of appearance improvement. This permits the assessment of beauty to be moved from a subjective to an objective realm and permits the quantifiable assessment of a user's appearance before and after the performance of one or more aesthetic improvement procedures.

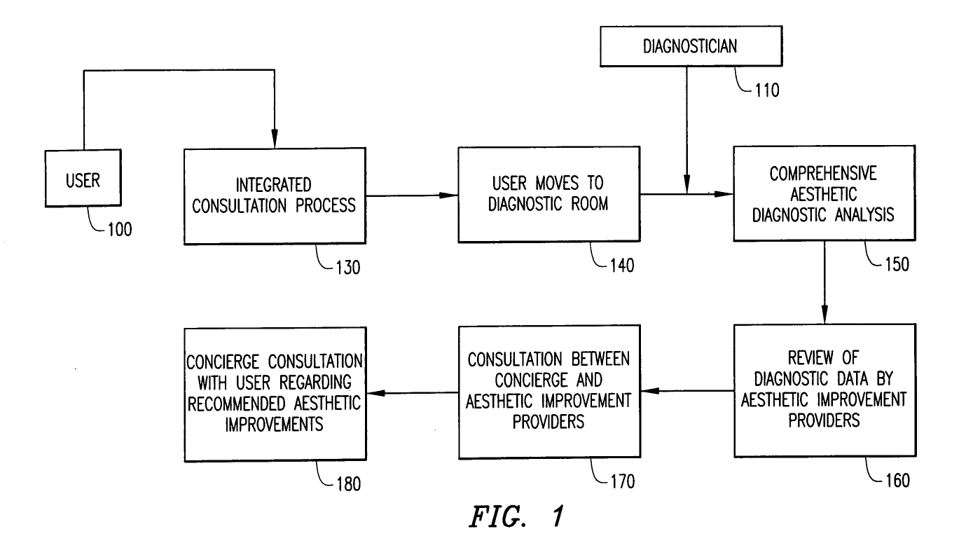

FIG. 1 illustrates an embodiment consistent with the methods of the invention. Consistent with this embodiment, a user (100) meets with a concierge (120), a highly trained professional, and becomes engaged in an integrated consultation process (130). During the consultation process, the user informs the concierge of their aesthetic improvement issues, and the concierge informs the user of all nine aesthetic improvement domains in a comprehensive fashion. For example, the concierge could separately inform the user of salon-related aesthetic improvement domains like the use of a hair stylist, a hair colorist, a facial aesthetician, a make-up artist, or a fashion consultant, as well as medically related aesthetic improvement domains such as, plastic surgery, cosmetic dermatologist or a cosmetic dentist. Following the consultation process (130), the user moves to a diagnostic room (140) and meets with a diagnostician (110). The diagnostic room is a specially designed and outfitted room located inside a medical, salon or spa facility, where a user utilizes one or more user appearance assessment tools in the presence of a diagnostician (110). The diagnostician performs a comprehensive aesthetic diagnostic analysis (150) on the user including, but not limited to, administering a self perception questionnaire, taking an electronic photo of the user's face, conducting a beauty analysis on the user's face, conducting a wrinkle analysis on the user's face and conducting a teeth whiteness measurement. The collected diagnostic data is reviewed by relevant aesthetic improvement providers (160) who consult with the concierge regarding recommended aesthetic improvement procedures (170) and their compatibility with one another. A draft recommended aesthetic improvement plan is then formed. The concierge then consults with the user (180) and provides the user with information regarding recommended aesthetic improvements as well as the draft aesthetic improvement plan specifically designed for the user. The steps 160, 170 and 180 may be repeated as necessary to achieve a final comprehensive aesthetic improvement plan for implementation.

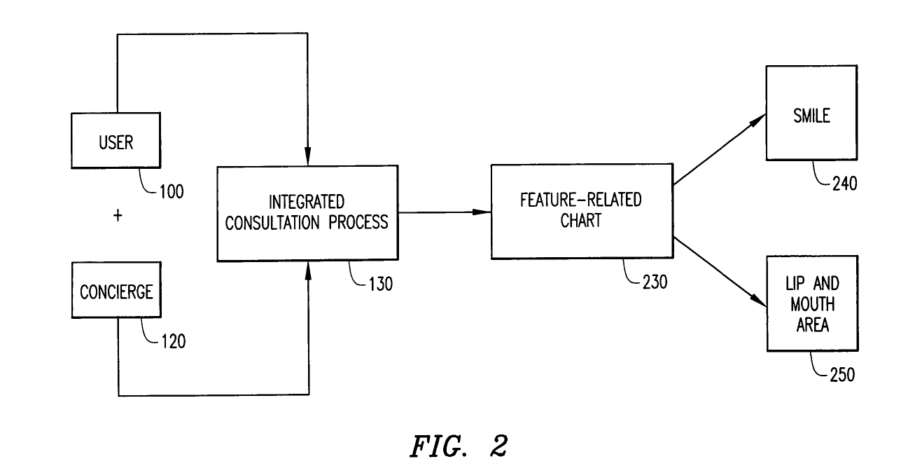

FIG. 2 illustrates an embodiment of the invention in which the consultation process (130) between a user (100) and a concierge (120) includes the use of a feature-related flip chart (230) that utilizes pictures of a user's facial and body features with descriptions of specific issues related to each of the facial and body features. For example, one of the features that may be considered is the user's smile (240). With respect to this feature, the issues to be considered include, but are not limited to, tooth color, tooth shape, tooth size, crooked teeth, missing teeth, uneven smile, gum problems and quality of breath. Another feature that could be considered is the user's lip and mouth area (250). With respect to this feature, the issues to be considered include, but are not limited to, lip size, lip shape, laugh lines, wrinkles, unwanted hair, corners of the mouth, lip color and skin texture. Other facial features such as eye shape, eyebrows, chin, jowls, cheeks, nose, and the like can be evaluated using the chart. Additionally, body features such as chest, arms, waist, hips, thighs and the like can be similarly evaluated using the feature-related flip chart.

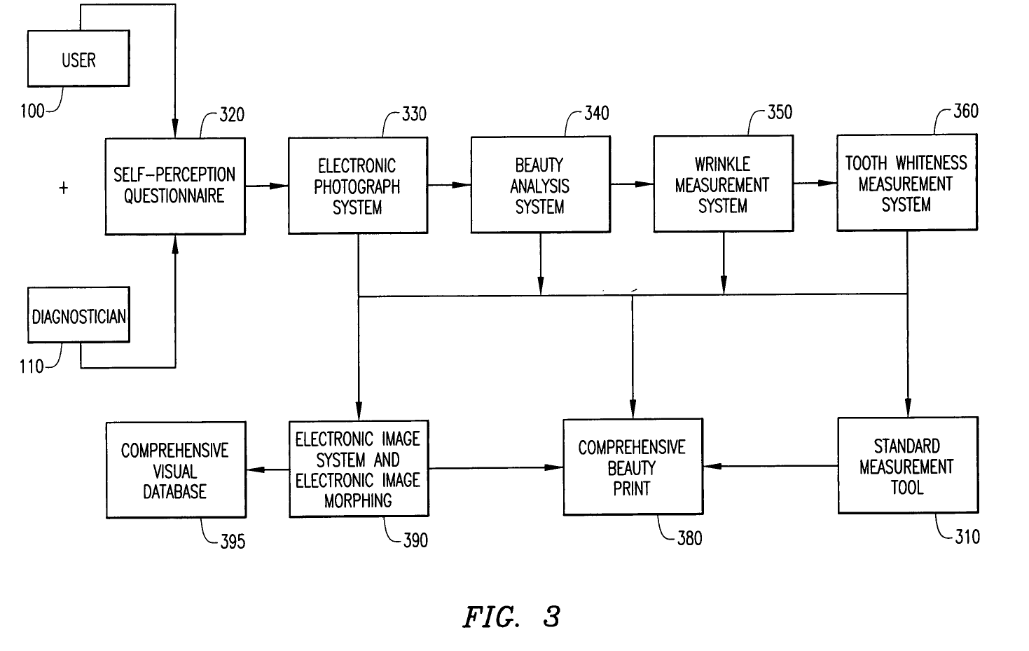

FIG. 3 illustrates an embodiment of the invention which utilizes one or more user appearance assessment tools to assess a user's appearance either before or after the performance of one or more aesthetic improvement procedures. In the illustrated embodiment, a user (100) consults with a diagnostician (110), who employs specific user appearance assessment tools to evaluate the user's appearance. The user appearance assessment tools employed in the illustrated embodiment are a self perception questionnaire (320), which is used to measure a user's satisfaction and dissatisfaction with specific features of their face, body and self image; an electronic photograph system (330), which facilitates the assessment of visual changes that occur from aesthetic improvement procedures by standardizing “before” and “after” user photos; a beauty analysis system (340), which measures the symmetry of the features on a user's face and then “draws” (using a mask overlay) an ideal feature symmetry of each facial feature to provide guidance to the relevant aesthetic improvement providers; a wrinkle measurement system (350), which visually rates the degree of user skin wrinkling in the forehead, eyes, lips, ear area and chin; a tooth whiteness system (360), which measures the whiteness level of a user's teeth; a standardized measurement tool (370), which is similar to the self perception questionnaire (320), but is provided to the user after the performance of one or more aesthetic improvement procedures; and, a comprehensive beauty blueprint (380), which is provided to the user both before and after the performance of one or more aesthetic improvement procedures and includes the results of any diagnostic assessments conducted as well as a post-procedure review by a panel of aesthetic experts. Images from the electronic photograph system may be morphed to take into account the changes that aesthetic improvement procedures will create on the user (390) and stored in a comprehensive visual database (395).

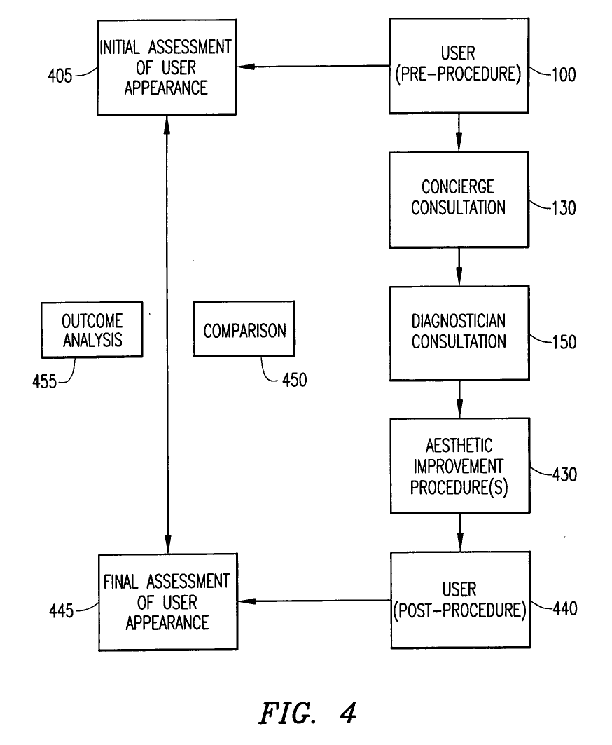

FIG. 4 illustrates an embodiment of the invention which provides a user with a method of retrospectively measuring the outcome of one or more aesthetic improvement procedures. A user (100) undergoes, in order, a pre-procedure user appearance assessment (405), where one or more user appearance assessment tools are applied to the user to generate a user appearance profile prior to the performance of any procedure; a concierge consultation (130), where the user informs the concierge of their aesthetic improvement issues, and the concierge informs the user of all nine aesthetic improvement domains in a comprehensive fashion; a diagnostician consultation (150), where a diagnostician performs a comprehensive aesthetic diagnosis on the user including, but not limited to, administering a self perception questionnaire, taking an electronic photo of the user's face, conducting a beauty analysis on the user's face, conducting a wrinkle analysis on the user's face and conducting a teeth whiteness measurement; and finally, one or more aesthetic improvement procedures (430). The aesthetically improved user (440) is subjected to a user appearance assessment (445) using one or more user appearance assessment tools. The user appearance assessment (445) of the aesthetically improved user is compared (450) to the initial user appearance assessment (405) to provide the user with a retrospective outcome analysis (455).

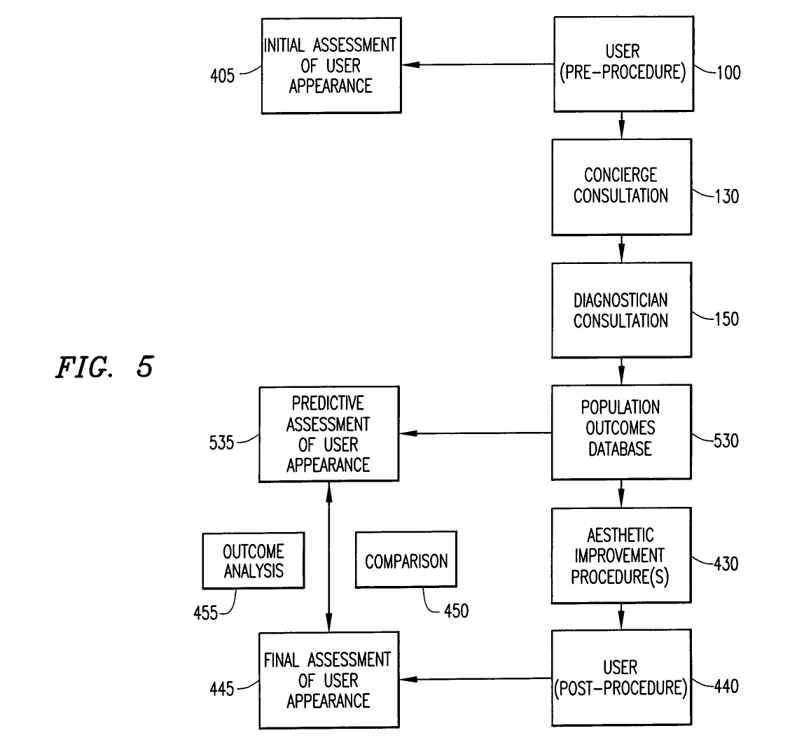

FIG. 5 illustrates an embodiment of the invention which provides a user with a method of prospectively measuring the outcome of one or more aesthetic improvement procedures. A user (100) undergoes, in order, a pre-procedure user appearance assessment (405), where one or more user appearance assessment tools are applied to the user to generate a user appearance profile prior to the performance of any procedure; a concierge consultation (130), where the user informs the concierge of their aesthetic improvement issues, and the concierge informs the user of all nine aesthetic improvement domains in a comprehensive fashion; and, a diagnostician consultation (150), where a diagnostician performs a comprehensive aesthetic diagnosis on the user including, but not limited to, administering a self perception questionnaire, taking an electronic photo of the user's face, conducting a beauty analysis on the user's face, conducting a wrinkle analysis on the user's face and conducting a teeth whiteness measurement. The aesthetic diagnostic data collected is correlated with pre-existing data in a population outcomes database (530). The database (530) contains objective measurements/data of improvements in prior users who have undergone one or more of the same or substantially similar aesthetic improvement procedures performed on the user (100). After the user's aesthetic diagnostic data has been correlated to the data in the outcomes database (530), a predictive assessment of the user's appearance is generated (535). Following the predictive assessment of the user's appearance, the user undergoes one or more aesthetic improvement procedures (430). The post-procedure user (550) is subjected to a user appearance assessment (555). The user appearance assessment (445) of the aesthetically improved user is compared (540) is compared to the predictive user appearance assessment (535) and analyzed (545) to ascertain the similarities between the predicted outcome (535) with the actual result (445).

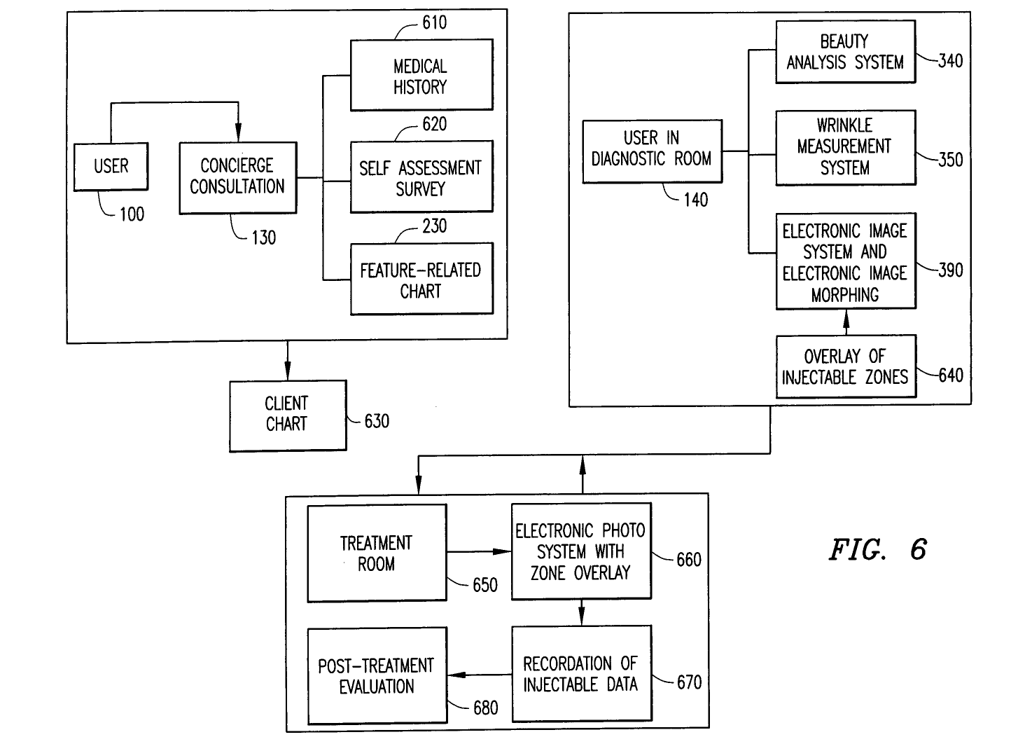

FIG. 6 illustrates an embodiment of the invention using a procedure to create repeatable results in cosmetic dermatology delivery services. A user (100) participates in a consultation with a concierge (130). During the consultation (130), the concierge collects information from the user pertaining to the user's medical history (610). In addition, the user (100) completes a self assessment survey (620) and completes a feature-related chart (230). The results from the user's medical history (100), self assessment survey (620) and feature-related chart (230) are compiled into a client chart or user chart (630). The user moves to a diagnostic room (140) where a diagnostician performs a beauty analysis (340), wrinkle measurement (350), electronic imaging and electronic image morphing (390). In the electronic imaging step (390), standardized photos (for e.g., Canfield medical photos) of the user are taken. In the wrinkle measurement step (350), a wrinkle assessment of the user's face is taken for the target areas identified by the user. In the beauty analysis step (340), an electronic mask is generated and placed over the electronic photos of the user's face. A zone map of the target areas for intervention (for e.g., BOTOX® injections and/or administration of soft tissue fillers) is overlaid on the electronic photos of the user (640). The user has a pre-treatment consultation with a physician. The user moves to a treatment room (650). A medical professional reviews the electronic photo of the user with the overlaid zones (640) and enters data into the zone areas of the electronic photo in accordance with the treatment to be administered. A physician administers the specific treatment (for e.g., BOTOX® injections and/or administration of soft tissue fillers) in accordance with the data obtained from the zone-overlaid photographs, which is recorded (670). A post-treatment evaluation (680) of the user is conducted. The evaluation includes a review of potential adverse reactions following the administration of the treatment.

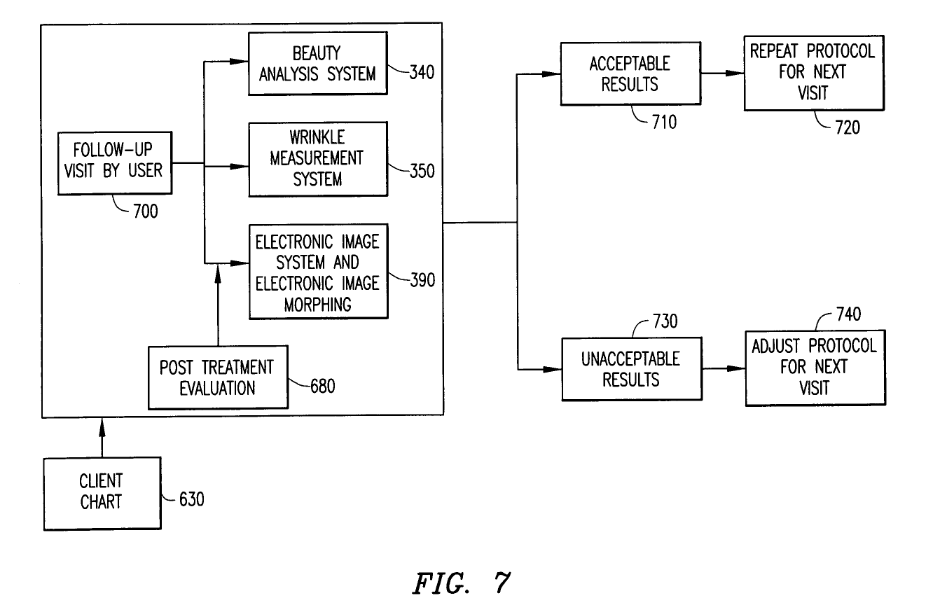

FIG. 7 illustrates an embodiment of the invention demonstrating the consistency and repeatability of a cosmetic dermatology procedure. A user (100) undergoes a cosmetic dermatological procedure in accordance with the methods set forth in FIG. 6. After the passage of time following the treatment, the user returns for a follow-up visit (700). A beauty analysis procedure (340), wrinkle measurement procedure (350), and electronic imaging and electronic image morphing (390) procedure is conducted on the user. In addition, the post-treatment evaluation data (680) of the user is also reviewed. All of the information is compiled in the user chart or client chart (630). The information gathered during the user's follow-up visit to ascertain the acceptability of the results to the user and the physician who administered the treatment. If the results are acceptable (710) to the user and physician, the treatment protocol may be repeated during the user's next visit (720). If the results are unacceptable either to the user or to the physician (730), the treatment protocol is adjusted prior to or during the user's next visit (740).

### EXAMPLE 1

A user is interested in having one or more aesthetic improvement procedures performed. The user visits a concierge (120) for a consultation (130) and shares several issues that she would like to have addressed including, but not limited to, tired-looking eyes, weight, size of nose, hair style and discolored teeth. The concierge performs a diagnosis (150) using one or more tools including, but not limited to, self-perception questionnaire tool (320), facial electronic photograph tool (330), facial beauty analytical tool (340) and facial measurement wrinkle tool (350). The diagnostic data acquired through the use of the tools is presented by the concierge to one or more providers of aesthetic improvement procedures (160). In the present example, the providers selected may include a hair stylist, hair colorist, facial aesthetician, make-up artist, fashion consultant, plastic surgeon, cosmetic dermatologist and cosmetic dentist. The aesthetic improvement providers provide the concierge with feedback (170) on potential areas of improvement for user's face and body. The concierge provides the user with a comprehensive report which includes the results of the diagnostic assessments, an outcomes report containing results achieved by previous users for the same procedures proposed for the current user, and results from an electronic photo system containing the feedback from the aesthetic improvement providers (180). This latter step permits the concierge to obtain directional view of the impact of the proposed aesthetic improvement procedures and the costs associated with performing the procedures.

As a result of the consultation, the user is recommended the following aesthetic improvement procedures: eyelid surgery, eyebrow shaping, BOTOX® treatment, new make-up, new hairstyle, new hair color, ceramic laminates and whitening for teeth. After pursuing the aesthetic improvement procedures, the user meets the concierge to obtain a post-procedure outcomes assessment which includes a satisfaction report competed by the user, facial electronic photograph and wrinkle analysis. This is followed by a comparison of pre- and post-procedure user appearance assessments to determine the degree of the aesthetic improvement in an objective manner.

### EXAMPLE 2

An exemplary embodiment of the invention is carried out for two users A and B. A survey tool measures the user's orientation of their own appearance (importance placed on appearance), self evaluation of their own appearance and level of satisfaction with their appearance. The survey tool features a 1-5 scale for measurement of user responses.

A beauty analysis tool is applied to users A and B before and after the performance of aesthetic improvement procedures as a means to measure the movement of a user's aesthetic appearance from start to finish. Under the Marquardt system, the basis for measurement is the phi factor ratio, which is a known mathematical tool for measurement of beauty and symmetry. Under this system, feature perfection is standardized using a 1,000 point scale, where 1000 equals perfect facial feature symmetry (that includes individual features as well as the aggregate of all features taken together). In the case of user A the Marquardt data before the performance of an aesthetic improvement procedure is 505 out of a possible 1000. The value for the same post-treatment is 835, i.e., an improvement of 330 points or 39.5%. In the case of user B, the pre-procedure treatment value is 600 and the value after treatment is 785, i.e., an improvement of 185 points or 23.5%.

A wrinkle measurement tool having an assessment scale of 0 to 5 is applied to users A and B. Prior to the performance of an aesthetic improvement procedure the wrinkle measurement (Lemperle data) for user B is “4” for the forehead region and “5” for the neck region. Following the performance of an aesthetic improvement procedure, the Lemperle score for user B's forehead is “2” and the value for the user's neck is “3”. The overall improvement for the two areas tested is 45%.

A panel of experts is assembled comprising a concierge, plastic surgeon, cosmetic dermatologist, cosmetic dentist, hair stylist, hair colorist, makeup artist, fashion consultant, aesthetician and beauty magazine editor. The panel reviews and completes an outcome survey tool. The outcome survey tool is measured on a scale of 0 to 5.

The results of the application of an exemplary embodiment of the invention on users A and B is summarized below:

| | | | Outcome | Weight |
|---|---|---|---|---|
| | User A | User B | Summary* | Value |
| User Procedure | 4.95 | 4.95 | 1 | 36% |
| Satisfaction | | | | |
| Beauty Analysis | +39.2% | +23.5% | 1 | |
| Wrinkle Analysis | N/A | +45% | 1 | |
| Combination of | +39% | +39% | 1 | 13.5% |
| Beauty Analysis | | | | |
| and Wrinkle | | | | |
| Analysis | | | | |
| Panel of Experts | 4.73 | 4.53 | 1 | 22.5% |
| Adverse Effects | 0 | 0 | 1 | 10% |
| Total Score | 1 | 1 | | 100% |

*Outcome summary is a weighted average of the combined data obtained from user surveys and quantifiable metric data where “1” indicates a perfect outcome and “−1” indicates worst possible outcome.

### EXAMPLE 3

An exemplary embodiment of the invention in accordance with FIGS. 6 and 7 is carried out on a female user. The user (100) undergoes an aesthetics concierge consultation (130) with a concierge. The user's medical history (610) is gathered, aesthetic feature-related chart information (230) is gathered, and self-reported client assessment data (620) is gathered. The concierge places the gathered information in the user's chart (630). The user expresses an interest in BOTOX® injections to reduce wrinkles in her forehead and soft tissue filler to plump up her upper lip. The user enters a diagnostic room (140) and meets with an aesthetic diagnostician. Standardized Canfield medical photos (390) are taken including a frontal view in repose at an 18% down angle for use with the Marquardt beauty analysis system (340). A Lemperle wrinkle measurement system (350) is performed on the target areas that the user desires to treat with BOTOX® and/or soft tissue fillers. The analysis reveals the level of wrinkles in a specific target region. A Marquardt beauty analysis system (340) is conducted and an electronic mask is placed over the electronic photo of the frontal view of the user's face. The electronic mask allows assessment of a user's features, for e.g., whether the user's upper lip is ideally proportioned relative to the rest of the user's face. A “zone map” of the target areas for BOTOX® injections and soft tissue filler is overlaid (640) on the user's electronic photo by the diagnostician. The diagnostician notes down the information in the user's chart (630).

The user has a physician consultation with a cosmetic dermatologist, plastic surgeon or cosmetic dentist. The physician conducts a pre-treatment evaluation of the user. The physician concludes the client is a candidate for BOTOX® in the glabella and eye regions as well as for a soft tissue filler in the upper area. The physician places the above information in the user's chart (630).

The user is escorted to a treatment room (650). The user receives a “pre-treatment” relaxation procedure from a medical aesthetician. While the user is receiving the relaxation procedure, a medical assistant and the physician review the electronic photo of the user with the “zone map” overlay (640) and confer regarding the course of treatment to be administered. The physician administers the BOTOX® and soft tissue filler treatment and the medical assistant records (670) the specific zone location and concentration of BOTOX® and filler being administered to each zone. Following the treatment, the user undergoes a post-treatment evaluation (680).

After a specific period of time, the user returns for a follow-up visit (700). During the follow-up visit, the user is interviewed by the concierge to gauge the user's satisfaction with the treatment. The user is re-photographed using the Canfield system (390). The beauty analysis system (340) is administered to observe the effects of the treatment and to allow a comparison between the user's “before” and “after” images. A wrinkle assessment (350) is also performed to gauge the reduction of wrinkling in the target areas. The physician meets with the user to conduct a post-treatment evaluation (680). The evaluation includes a review of potential adverse reactions. The evaluation includes a review of at least three photographs of the user's face-the “before” photo of the user's face with call-outs of the wrinkle and upper lip issues; the “before” photo of the user's face with the target (zone) areas filled in by the medical assistant which show the client where the BOTOX® and soft tissue was administered; and, the “after” photo of the user's face with call-outs to show the improvements achieved. The wrinkle assessment and beauty analysis data are also reviewed to assess the quantitative improvement in the user's appearance. In addition, the physician reviews the user's satisfaction survey and confirms the user's satisfaction with the results of the treatment.

One of three likely scenarios can result from post-treatment evaluation discussion between the user and the physician. In a first scenario the results are satisfactory and acceptable (710) to both the user and the physician. The user's chart (630) indicates the protocol used for the BOTOX® injections and soft tissue fillers that created the desired result. In this scenario the same or similar approach may be administered during the user's next visit (720). In a second scenario, the results are satisfactory to the user but not to the physician (730). The physician will modify the user's chart (630) to change the treatment to be administered to the user during the next visit (740). In a third scenario, the results are satisfactory to the physician but not to the user (730). As in the case of the second scenario, the physician will modify the user's chart (630) to change the treatment to be administered to the user during the next visit (740).

1. A method of providing a user with an aesthetic improvement procedure comprising:
obtaining information from the user regarding the aesthetic improvements desired by the user,
consulting with individual providers of aesthetic improvements for recommendations,
developing a comprehensive aesthetic improvement plan,
performing the recommended aesthetic improvement procedures, and
assessing the outcome of the aesthetic improvements in an integrated and objective manner.

2. The method of claim 1, wherein the information includes queries.

3. The method of claims 1 or 2, wherein the aesthetic improvement procedure includes at least one of a product recommendation, a diagnostic recommendation, a cosmetic usage recommendation, and a procedure recommendation.

4. The method of claim 2, further comprising recording answers to the queries and asking the user additional queries incorporating into the additional queries information reflective of recorded answers.

5. The method of claim 1, wherein maintaining user-specific information involves storing the information on a storage device.

6. The method of claim 1, wherein maintaining user-specific information involves providing access to a remote location where the information is maintained.

7. The method of claim 2, wherein receiving user-specific information includes recording answers to the queries.

8. The method of claim 1 wherein the aesthetic improvement procedure is plastic surgery.

9. The method of claim 1 wherein the aesthetic improvement procedure is cosmetic dermatology.

10. The method of claim 1 wherein the aesthetic improvement procedure is cosmetic dentistry.

11. The method of claim 1 wherein the aesthetic improvement procedure is hair styling

12. The method of claim 1 wherein the aesthetic improvement procedure is hair coloring.

13. The method of claim 1 wherein the aesthetic improvement procedure is facial aesthetics.

14. The method of claim 1 wherein the aesthetic improvement procedure is makeup artistry.

15. The method of claim 1 wherein the aesthetic improvement procedure is fashion and eyewear consultation.

16. The method of claim 1 wherein the aesthetic improvement procedure is nail care.

17. A method of providing a user with an outcome to an aesthetic improvement procedure comprising the step of using one or more tools to assess user appearance.

18. The method of claim 17 wherein said one or more tools are used before the performance of the aesthetic improvement procedure.

19. The method of claim 17 wherein said one or more tools are used following the performance of the aesthetic improvement procedure.

20. The method of claim 17 wherein said tool is a concierge.

21. The method of claim 17 wherein said tool is a consultation process.

22. The method of claim 17 wherein said tool is a feature-related flip chart.

23. The method of claim 17 wherein said tool is a diagnostic room.

24. The method of claim 17 wherein said tool is a diagnostician.

25. The method of claim 17 wherein said tool is a self-perception questionnaire.

26. The method of claim 17 wherein said tool is an electronic photographic system.

27. The method of claim 17 wherein said tool is an electronic image database.

28. The method of claim 17 wherein said tool is an electronic system for morphing electronic image.

29. The method of claim 17 wherein said tool is a user satisfaction survey.

30. The method of claim 17 wherein said tool is a beauty analysis system.

31. The method of claim 17 wherein said tool is a wrinkle measurement system.

32. The method of claim 17 wherein said tool is a tooth whiteness measurement system.

33. The method of claim 17 wherein said tool is an expert panel measurement tool.

34. The method of claim 17 wherein said tool is a beauty blueprint report.

35. The method of claim 17 wherein said tool is an outcomes measurement report.

36. A method of providing a user with an outcome to an aesthetic improvement procedure comprising:
providing the user with a single systems integrator who manages the user's aesthetic improvement.

37. The method of claim 36 wherein said single systems integrator is a concierge.

38. A method of measuring the outcome of one or more aesthetic improvement procedures performed on a user comprising:
measuring the results of the one or more aesthetic improvement procedures objectively to determine the outcome of the one or more aesthetic improvement procedures.

39. The method of claim 38 wherein said outcome is a retrospectively determined outcome.

40. The method of claim 38 wherein said outcome is a prospectively or predictively determined outcome.

41. The method of claim 39 wherein said retrospectively determined outcome is determined by comparing the user's appearance after the performance of the one or more aesthetic improvement procedures to the user's appearance before the performance of the one or more aesthetic improvement procedures.

42. The method of claim 41 wherein said retrospectively determined outcome is determined by using one or more user appearance assessment tools.

43. The method of claim 40 wherein said prospectively determined outcome is based on appearance improvement data of prior users who have undergone the specific or substantially similar aesthetic improvement procedures.

44. A method of providing a user with an outcome to an aesthetic improvement procedure comprising:
performing the aesthetic improvement procedure,
recording the step-wise performance of the aesthetic improvement procedure,
assessing the results of the aesthetic improvement procedure,
compiling the results of the aesthetic improvement procedure in a database,
consulting the compiled results, and
repeating the aesthetic improvement procedure.

45. The method of claim 44 wherein the aesthetic improvement procedure is repeated more than once.

46. The method of claim 44 wherein the aesthetic improvement procedure is selected from the group consisting of botulinum toxin injections, soft tissue filler injections and laser treatments and combinations thereof.
